(19) United States
(12) Patent Application Publication
(10) Pub. No.: US 2024/0047927 A1
(43) Pub. Date: Feb. 8, 2024

(54) Pluggable Power Supply Wire Harness

(71) Applicant: Cheng-Hui Huang, Kaohsiung City (TW)

(72) Inventors: Cheng-Hui Huang, Kaohsiung City (TW); Shuang Pi, Dongguan City (CN)

(21) Appl. No.: 18/360,053

(22) Filed: Jul. 27, 2023

(30) Foreign Application Priority Data
Aug. 2, 2022 (TW) 111208311

(51) Int. Cl. H01R 24/28

(52) U.S. Cl. CPC H01R 24/28; H01R 2201/06

(57) ABSTRACT

A pluggable power supply wire harness includes a PCI-E pluggable wire harness which has a power receiving terminal at one end thereof and first and second power transmitting terminals at the other end thereof. Each of the power receiving terminal, the first power transmitting terminal and the second power transmitting terminal is equipped with 8 pins wherein pins 1, 2 and 3 of the power receiving terminal are prepared for supply of +12V and pins 5, 6, 7 and 8 are defined as grounding pins. The pluggable wire harness is further provided with a leading wire which has a first end connected with the pin 4 of the power receiving terminal and a second end connected with one of pins 1, 2 and 3 of the power receiving terminal or connected with one of pins 1, 2 and 3 of the first and second power transmitting terminals.

### BACKGROUND OF THE INVENTION

### 1. Field of the Invention

The present invention relates to a pluggable power supply wire harness and, more particularly, to a pluggable PCI-E wire harness applied as a modularized power output wire harness.

### 2. Description of the Related Art

PCI Express (Peripheral Component Interconnect Express, PCI-E for short) which is a crucial branch among computer buses inherits existing PCI programming concepts and communications standards for creation of higher-speed serial communications system standards. These serial standards are being enacted and maintained by the PCI Special Interest Group (PCI-SIG). PCI-E acclaimed for its higher speed has almost replaced other conventional internal buses, for example, AGP AGP (Accelerated Graphics Port) and PCI (Peripheral Component Interconnect). Additionally, a PCI-E device characteristic of hot plugging and swap supports three different voltages, that is, +3.3V, 3.3Vaux (auxiliary voltage), and +12V. In virtue of more and more power consumed by a graphics card, the subsequent specification for the limitation of power directly received from a PCI-E slot has been revised, for example, the maximum power, up to 75W, supplied for a PCI-E×16 slot has been upgraded compared with the AGP 8× interface. With compatibility of PCI-E guaranteed, the operating system that supports PCI also supports the PCI-E bus without any modification required. It is convenient for a user who intends to upgrade his/her computer. Accordingly, PCI-E with greatest significance of universality is used in connectivity with the south bridge chip and another device, expanded connectivity between chipsets or even connectivity with the graphics processing unit. As such, the whole I/O system is reunited for a computer system further simplified and computer hardware portable and modulaized.

FIG. 1 illustrates a traditional modularized power output wire harness, i.e., a pluggable PCI-E wire harness 10 consisting of three wires for 12V and five wires for GND (Ground). The pluggable wire harness 10 features a power receiving terminal 11 at one end thereof and a first power transmitting terminal 12 as well as a second power transmitting terminal 13 at the other end thereof. The power receiving terminal 11 is connected with a power supply for power-taking. Each of the first power transmitting terminal 12 and the second power transmitting terminal 13 is plugged into a socket on a graphics card for power transmitting. The power receiving terminal 11 is a connector featuring pin 1 to pin 8 wherein pins 1, 2 and 3 are prepared for supply of +12V, pin 4 is not applicable (N/A) and pins 5, 6, 7 and 8 are defined as grounding pins (GND) or pins 1, 2 and 3 are prepared for supply of +12V and pins 4, 5, 6, 7 and 8 are defined as grounding pins (GND). Each of the first power transmitting terminal 12 and the second power transmitting terminal 13 is plugged into a socket on a graphics card and includes pins 1, 2 and 3 prepared for supply of +12V, and pins 4, 5, 6, 7 and 8 defined as GND. As shown in a simulation test, the current checked at the pluggable PCI-E wire harness 10 is 24A and each pin of the power receiving terminal 11 sustains 8A. That is, the phenomenon that high load resistance induces significant temperature rise is observed at the pluggable PCI-E wire harness 10. When a graphics card has sustained current load for a long time, the high load resistance at the power receiving terminal 11 usually leads to terminal interfaces and wires over-temperature or burnt because of three terminal interfaces in the power receiving terminal 11, pin 1 to pin 3, for power receiving, and other six terminal interfaces in the first power transmitting terminal 12 as well as the second power transmitting terminal 13 for power transmitting.

For settlement of the above problem, a modularized pluggable power supply wire harness, which is more practical than ever, as the goal and the direction of the industry, deserves to be further researched.

### BRIEF SUMMARY OF THE INVENTION

Thus, an objective of the present invention is to provide a pluggable power supply wire harness, which can help with the problem of power receiving terminal interfaces/wires burnt and avoid hardware component damaged for good practical efficiency.

To achieve this and other objectives, a pluggable power supply wire harness according to an embodiment of the present invention is applied as a modularized power output wire harness and includes a pluggable wire harness. The pluggable wire harness has a power receiving terminal at an end thereof and a first power transmitting terminal as well as a second power transmitting terminal at the other end thereof. The power receiving terminal is connected with a power supply for power-taking, and each of the first and second power transmitting terminals is adapted to be plugged into a socket on a graphics card for power transmitting. The power receiving terminal is equipped with 8 pins, wherein pins 1, 2 and 3 thereof are prepared for supply of +12V and pins 5, 6, 7 and 8 thereof are defined as grounding pins. Each of the first and second power transmitting terminals is equipped with 8 pins, wherein pins 1, 2, and 3 thereof are prepared for supply of +12V and pins 4, 5, 6, 7 and 8 thereof are defined as grounding pins. The pluggable wire harness is characterized in that the pin 4 of the power receiving terminal of the pluggable wire harness is connected with one end of a leading wire, and another end of the leading wire is connected with one of the pins 1, 2 and 3 of the power receiving terminal, or connected with one of the pins 1, 2 and 3 of the first and second power transmitting terminals.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 is a schematic view for the structure of a traditional pluggable wire harness, with an end face view of a power receiving terminal thereof and two end face views of first and second power transmitting terminals thereof

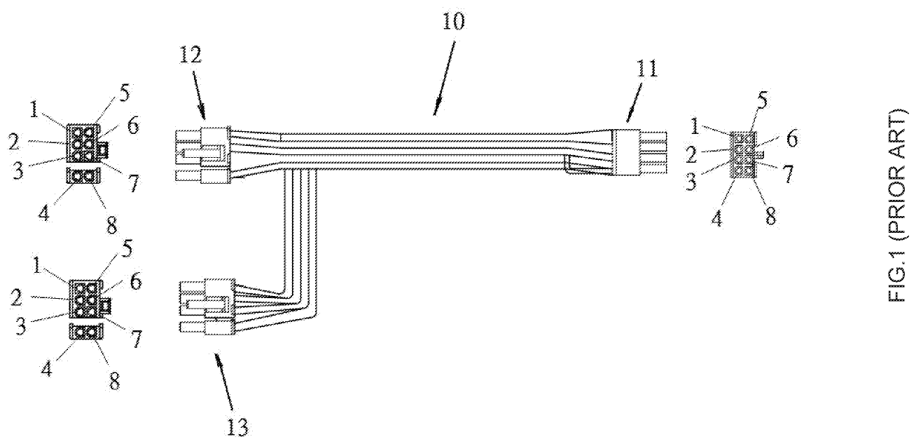

FIG. 2 is a schematic view for the structure of a pluggable power supply wire harness of the present invention, with an end face view of a power receiving terminal thereof and two end face views of first and second power transmitting terminals thereof.

FIG. 3 is an end face view of the power receiving terminal of the pluggable power supply wire harness in FIG. 2, with a leading wire connected to the pin 4 of the power receiving terminal and the pin 1 of the power receiving terminal.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Where used in the various figures of the drawings, the same numerals designate the same or similar parts.

### DETAILED DESCRIPTION OF THE INVENTION

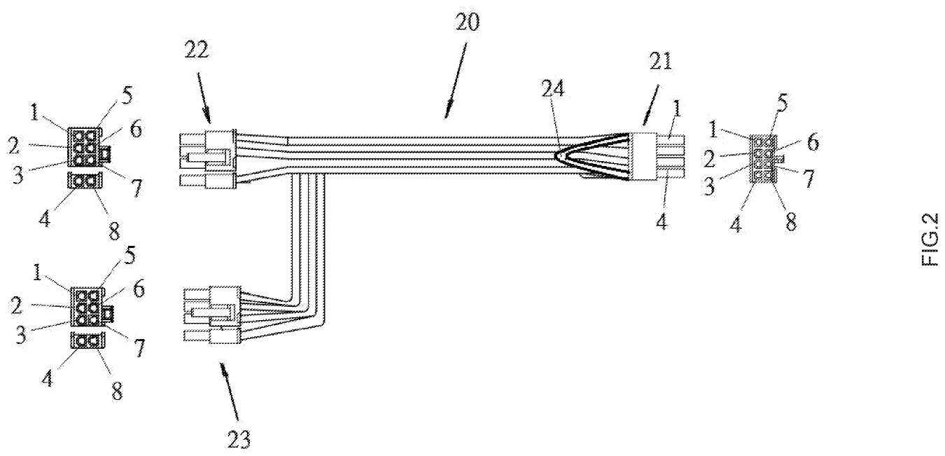

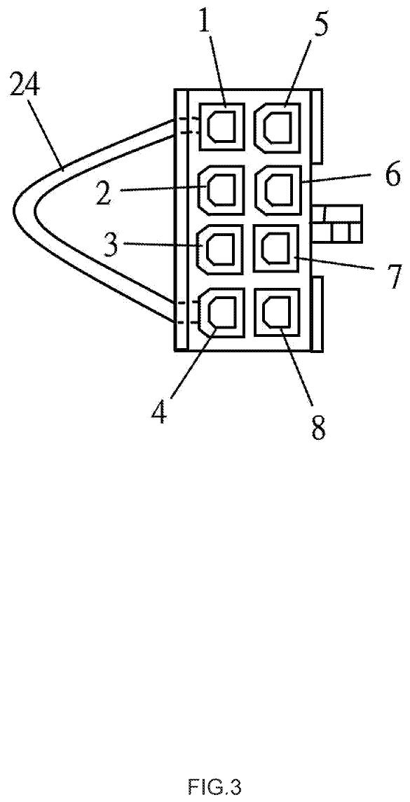

A pluggable power supply wire harness according to the preferred teachings of the present invention is shown in FIGS. 2 and 3 of the drawings and generally includes a pluggable wire harness 20. The pluggable wire harness 20 is provided with a power receiving terminal 21 at an end thereof and a first power transmitting terminal 22 as well as a second power transmitting terminal 23 at the other end thereof. The power receiving terminal 21 is connected with a power supply for power-taking. Each of the first power transmitting terminal 22 and the second power transmitting terminal 23 can be plugged into a pin socket of a device such as a graphics card for power transmitting. The power receiving terminal 21 is a connector featuring pin 1 to pin 8 (jacks 1 to 8), wherein pins 1, 2, and 3 are prepared for supply of +12V, and pins 5, 6, 7 and 8 are defined as grounding pins (GND). Each of the first power transmitting terminal 22 and the second power transmitting terminal 23 is adapted to be plugged into a socket on a graphics card and includes pins 1, 2 and 3 prepared for supply of +12V and pins 4, 5, 6, 7 and 8 defined as GND (Ground). The main feature of the pluggable wire harness 20 of the present invention is that the pin 4 of the power receiving terminal 21 of the pluggable wire harness 20 is further connected with an end of a leading wire 24, and the other end of the leading wire 24 is connected with one of the pins 1, 2 and 3 of the power receiving terminal 21, or connected with one of the pins 1, 2 and 3 of the first power transmitting terminal 22 or the second power transmitting terminal 23. In this embodiment, the other end of the leading wire 24 is connected with the pin 1 of the power receiving terminal 21 (see FIG. 3).

The pluggable wire harness 20 of the present invention is equipped with the leading wire 24 in structural design, and the leading wire 24 features an end connected to the pin 4 of the power receiving terminal 21 and the other end connected to any one of the pins 1, 2 and 3 of the power receiving terminal 21, or connected to any one of the pins 1, 2 and 3 of the first power transmitting terminal 22 or any one of the pins 1, 2 and 3 of the second power transmitting terminal 23.

According to the above structural design, the pluggable wire harness 20 of the present invention is characteristic of the following advantages. In the pluggable wire harness 20 consisting of 9 wires (four wires for 12V and five wires for GND), the additional branch wire for +12V contributes to current distribution at each pin. As shown in a simulation test for the current of 24A, the current checked at each pin of the power receiving terminal 21 is 6A (25% lower than the load current detected at a traditional PCI wire) and smaller load resistance induces temperature rise reduced significantly (20% less than the load temperature detected at the traditional PCI wire) for lowered electric load and reduced wire/plastic material temperature that help with the problem of power receiving terminal interfaces/wires burnt and avoid hardware component damaged for good practical efficiency.

In summary, the structure of pluggable wire harness 20 of the present invention contributes to current distribution, temperature reduction, extension of service life and durability. Accordingly, the problem of power receiving terminal interfaces and wires burnt is avoided because of loads lowered and wire/plastic temperatures reduced.

The scope of the invention is to be indicated by the appended claims, rather than by the foregoing description, and all changes which come within the meaning and range of equivalency of the claims are intended to be embraced therein.

1. A pluggable power supply wire harness comprising a pluggable wire harness having a power receiving terminal at an end thereof and a first power transmitting terminal as well as a second power transmitting terminal at another end thereof, wherein the power receiving terminal is connected with a power supply for power-taking, and each of the first and second power transmitting terminals is adapted to be plugged into a socket on a graphics card for power transmitting, wherein the power receiving terminal is equipped with 8 pins, with pins 1, 2 and 3 thereof prepared for supply of +12V and pins 4, 5, 6, 7 and 8 thereof defined as grounding pins, wherein each of the first and second power transmitting terminals is equipped with 8 pins, with pins 1, 2, and 3 thereof prepared for supply of +12V and pins 4, 5, 6, 7 and 8 thereof defined as grounding pins;
characterized in that the pin 4 of the power receiving terminal of the pluggable wire harness is connected with an end of a leading wire, and another end of the leading wire is connected with one of the pins 1, 2 and 3 of the power receiving terminal, or connected with one of the pins 1, 2 and 3 of the first and second power transmitting terminals.
